(19) United States
(12) Patent Application Publication
(10) Pub. No.: US 2024/0205220 A1
(43) Pub. Date: Jun. 20, 2024

(54) DIGITAL AUTHENTICATION SYSTEM

(71) Applicant: IP MANAGEMENT LIMITED LIABILITY COMPANY, Kobe (JP)

(72) Inventor: Kazuo YOSHIWARA, Kobe (JP)

(21) Appl. No.: 18/553,826

(22) PCT Filed: Jul. 16, 2021
(86) PCT No.: PCT/JP2021/026868

§ 371 Date: Oct. 3, 2023

(30) Foreign Application Priority Data
Jul. 13, 2021 (JP) 2021-115691

(51) Int. Cl. H04L 9/40

(52) U.S. Cl. CPC H04L 63/0853; H04L 63/083; H04L 63/0861

(57) ABSTRACT

The aim is to perform plain text communications over the network securely. Digital authentication system is equipped with a digital ID app that is installed on an IoT device with a SIM card and a registration unit to register official ID information in digital ID app through a registration device installed in a public institution, etc.

### TECHNICAL FIELD

The present invention is a technology to promote plain text internet communications by preventing unauthorized hijacking of accounts, reducing the burden of corporate cybersecurity measures by making it easier to deal with cyberattacks, and promoting the distribution of personal information.

### BACKGROUND ART

Patent Document 1 discloses a technology that accurately detects phishing websites engaged in unauthorized hijacking of accounts.

### PRIOR ART DOCUMENTS

### Patent Document

Patent Document 1: Unexamined Patent Publication No. 2021-33421

### SUMMARY OF THE INVENTION

### Problem to be Solved by the Invention

Credential information is stolen through phishing scams, MITB, etc., leading to their misuse in activities, such as illegal wire transfers. Phishing scams are difficult to prevent because they manipulate users into entering their credential information on fake websites or emails.

Although the technology to determine cyberattacks from the contents of communication packets has advanced, detecting attacks on the Internet has become difficult as most communications over the Internet are encrypted. Therefore, companies are investing significant resources in implementing security measures for their networks; however, if the use of plain text in communications over the Internet increases, detecting attacks on the Internet and blocking communications becomes possible, thereby reducing the burden on these companies.

In addition, encryption of communications has led to the oligopoly of personal information obtained on the Internet (including browsing history) by a few companies.

This occurs because users preferentially choose services offered by certain companies; however, the communication infrastructure utilized by internet companies is supported by government assistance and usage fees of individuals.

According to the global trend, the rights to personal information belong to the individual, and an oligopoly of profits derived from personal information by a few companies is not preferable.

For example, if communications over the Internet are carried out in plain text, service providers commissioned by the government can collect personal information (such as browsing history, etc.) within the scope stipulated by the law, sell this information, and use the revenues earned by selling the personal information to cover the operating and maintenance costs of the communication infrastructure, which could potentially lead to a reduction in the communication fees paid by individuals.

The present invention has been developed in view of the above circumstances and aims to facilitate secure plain text communication over networks.

### Means for Solving the Problem

For achieving the purpose mentioned above, the digital authentication system of the present invention is equipped with a digital ID app that is installed on an IoT device (Master) with a SIM card inserted and a registration unit to register official ID information in the digital ID app through a registration device installed in a public institution, etc.

Provide a digital authentication system that registers IDs such as My Number Card, driver's license, insurance card, etc., issued by a public institution as a digital ID on the app installed on a smartphone, links the digital ID to other IoT devices using an IC reader, generates a hash value based on the information of the linked digital ID, and uses the generated hash value as credential information, thus ensuring security even when sending credential information in plain text communication.

More suitably, the digital ID is equipped with a notification module that notifies the information of the IoT device (master) on which the digital ID app is installed to the management server, and the management server is equipped with a recording module that records the information notified by the notification module of the digital ID app.

More suitably, the management server is equipped with an acquisition module that acquires the credential information owned by the digital ID owner from the credential information management server, and the management server is also equipped with a recording module that records the credential information acquired by the acquisition module.

More suitably, equipped with a usage management module that disallows the use of the digital ID app in an IoT device (master) that does not have a SIM card inserted and an IoT device (master) on which a SIM card has been replaced and a deletion module that deletes information registered in the digital ID app when a certain period has elapsed after the SIM card has been removed from the IoT device (master).

More suitably, equipped with a biometric information registration unit that registers biometric information using the registration device installed in a public institution, etc., and a separately provided biometric authentication device is equipped with a biometric authentication unit that performs biometric authentication based on the biometric information registered by the biometric information registration unit, and a usage management module that suspends the use of the digital ID app based on the instructions of the user whose identity has been verified by performing identity verification with the biometric authentication unit.

More suitably, equipped with a usage management module that releases the usage suspension of the digital ID app based on the instructions of the user whose identity has been verified by the biometric authentication unit of the biometric authentication device.

More suitably, equipped with a deletion module that deletes the data of the digital ID app when a certain period has elapsed after the usage suspension is instructed by the usage management module of the biometric authentication device.

More suitably, equipped with an IC card issuance unit, which issues an IC card that can be used as an alternative to the digital ID app based on personal information stored in the management server when the user's identity is verified by performing identity verification with the biometric authentication unit.

More suitably, the biometric authentication device is equipped with an expiration date setting module that sets the expiration date of the IC card.

More suitably, when official ID information is registered in a new digital ID app through the registration unit of the registration device, the digital ID app is equipped with a notification module that notifies the management server of the new IoT device (master) information.

More suitably, equipped with a notification module that notifies of the usage suspension of the digital ID app before the registration change to the website is recorded in the recording module of the management server. The website notified of the usage suspension by the notification module of the management server is equipped with an online usage suspension module that suspends the use of the digital ID app before the registration change.

More suitably, the digital ID app is equipped with a hash value generation module that generates a hash value from the unique identifier of the official ID (personal identity number or driver's license number, etc.) and the unique identifier of the IoT device (master) on which the digital ID app is installed.

More suitably, equipped with a hash value provision module that sends the hash value generated by the hash value generation module to the management server.

More suitably, equipped with a hash value provision module that provides a hash value generated by the hash value generation module when browsing a website, etc., on the Internet, and the website is equipped with a hash value comparison module that compares the hash value provided by the hash value provision module with the hash value stored on the website to perform user authentication.

More suitably, the website is equipped with a usage restriction module that allows reviews for products and services only when user authentication has been performed by the hash value comparison module or by accounts that have completed one-time password authentication when a one-time password is sent by SMS to a non-prepaid cell phone.

More suitably, equipped with an authentication module that performs authentication through an IC reader between the IoT device (master) and the IoT device (slave) on which the digital ID app is installed and an authentication information retention module that retains the authentication information authenticated by the authentication module in the device.

More suitably, equipped with a password setting module that can set an arbitrary password when the authentication information retention module retains the authentication information, and the authentication module allows log in to the IoT device (slave) by entering the password during the period when the authentication information is retained.

More suitably, equipped with a hash value generation module that generates a hash value from the authentication information held in the authentication information retention module and the unique identifier of the IoT device (slave).

More suitably, the management server is equipped with a recording module, which records the IoT device (slave) that has retained the authentication information using the authentication information retention module, and a remote wipe module that gives instructions for the deletion of the authentication information retained in the authentication information retention module. The digital ID app has a deletion module that deletes the information when the specified IoT device (slave) is connected to the network.

More suitably, equipped with a location information setting module to set the location information that allows log in to the IoT device (slave) using the password registered in the password setting module.

More suitably, equipped with a hash value generation module that generates a hash value based on a unique identifier of the bank account or credit card number, etc., and the unique identifier of the user when a bank account, credit card, etc., is created on the website of a financial institution.

More suitably, equipped with an online usage suspension module that does not authenticate even if a bank account or credit card information, etc., is entered on the website when a hash value for authentication is generated from a unique identifier of the bank account or credit card number, etc., and the unique identifier of the user.

More suitably, equipped with a hash value provision module that provides hash values when browsing websites and a web browsing history management DB that stores the web browsing history based on the provided hash value.

More suitably, equipped with a digital ID reading app that displays information registered in the digital ID app when the IoT device on which the digital ID app is installed is held over the IC reader.

More suitably, equipped with a hash value comparison module that performs identity verification based on the comparison results of hash value when a client delegates work to a specialist on the website, such as an administrative scrivener, etc., who performs various procedures at the designated institution as a proxy of the client using a power of attorney, equipped with a notification module to notify that a procedure has been performed by an agent on the digital ID app of the client, and an approval module that allows the client to approve the contents notified by the notification module.

More suitably, equipped with a bot that crawls web pages, and the bot is equipped with an alert module that raises an alert when a web page that meets the prescribed conditions (email, messaging app, cloud storage, etc.) is published in plain text.

### Effect of the Invention

According to the digital authentication system of the present invention, plain text communication can be performed securely over the network.

### BRIEF DESCRIPTION OF THE DRAWINGS

FIG. 1 Drawing illustrating the schematic configuration of a digital authentication system according to an embodiment of the present invention.

FIG. 2 Flowchart illustrating the steps from acquiring a digital ID to its deletion in a digital authentication system.

FIG. 3 Flowchart illustrating the steps of the authentication process in a digital authentication system.

FIG. 4 Flowchart illustrating the process flow of acquiring a digital ID from an IoT device (slave) in a digital authentication system.

### MODE FOR CARRYING OUT THE INVENTION

An embodiment of the digital authentication system related to the present invention is explained below using a drawing. An official ID (identification information) such as a My Number card or driver's license, etc., is used as an example to explain this embodiment. However, using this embodiment to digitalize IDs issued by private companies, such as employee IDs, is also acceptable.

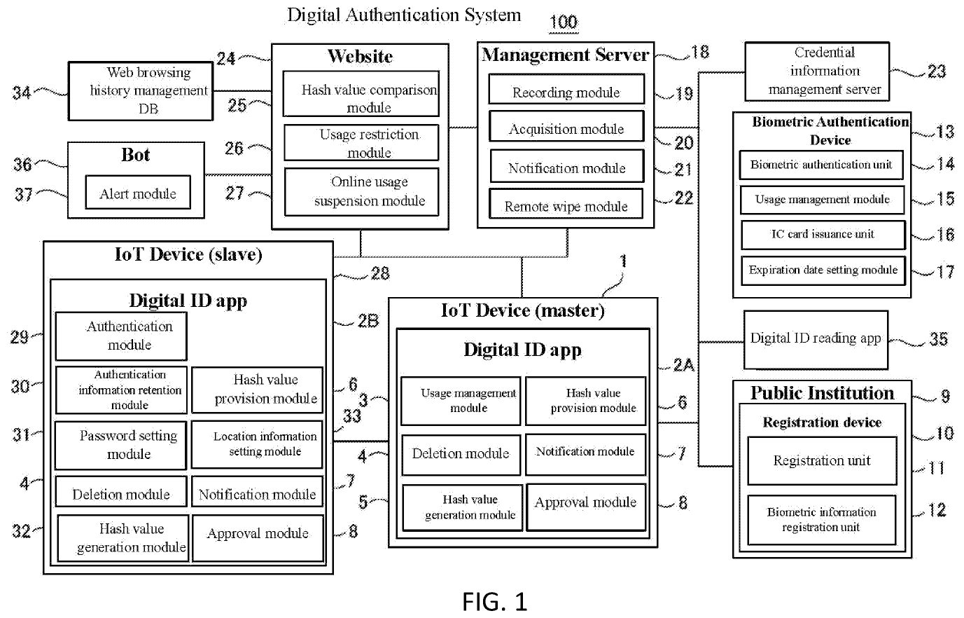

FIG. 1 is a drawing illustrating the schematic configuration of a digital authentication system.

In digital authentication system 100, IoT device (master) 1, IoT device (slave) 28, registration device 10 installed in public institution 9, biometric authentication device 13, management server 18, credential information management server 23, website 24, web browsing history management DB (database) 34, digital ID reading app 35, and bot 36 are connected.

The digital ID app 2A is installed on the IoT device (master) 1.

The digital ID app 2A includes usage management module 3, deletion module 4, hash value generation module 5, hash value provision module 6, notification module 7, and approval module 8.

The digital ID app 2B is installed on the IoT device (slave) 28.

The digital ID app 2B includes authentication module 29, authentication information retention module 30, password setting module 31, hash value generation module 32, hash value provision module 6, location information setting module 33, deletion module 4, notification module 7, and approval module 8.

Registration device 10 is equipped with registration unit 11 and biometric information registration unit 12.

The biometric authentication device 13 includes biometric authentication unit 14, usage management module 15, IC card issuance unit 16, and expiration date setting module 17.

The management server 18 includes recording module 19, acquisition module 20, notification module 21 and remote wipe module 22.

Website 24 includes hash value comparison module 25, usage restriction module 26 and online usage suspension module 27.

Digital IDs must be operated on devices that are difficult to retrieve or tamper with illegally. Therefore, installing digital ID app 2A on the IoT device (master) 1, in which the SIM card is inserted, is preferable.

Prepaid cellphones and tablets also use SIM cards. Therefore, it is preferable that digital ID app 2A should not be available for use on prepaid cellphones and tablets as the hardware for prepaid cellphones and tablets can be acquired easily.

There is a risk of theft or loss of the IoT device (master) 1 installed with the digital ID app 2A. For this reason, the digital ID app is equipped with notification module 7 that notifies information of the IoT device (master) 1 on which the digital ID app 2A is installed to management server 18, and management server 18 records the information notified by notification module 7 of digital ID app 2A in recording module 19.

Committing fraud would be difficult, and streamlining various administrative procedures would be easier if various credential information (national and private qualifications, school graduation certificates, TOEIC scores, vaccine passports, etc.) owned by an individual could be managed by linking to a digital ID app 2A. For this reason, management server 18 is equipped with an acquisition module 20 that acquires the credential information owned by the digital ID app 2A owner from the credential information management server 23. Management server 18 records the credential information acquired by acquisition module 20 in the recording module 19.

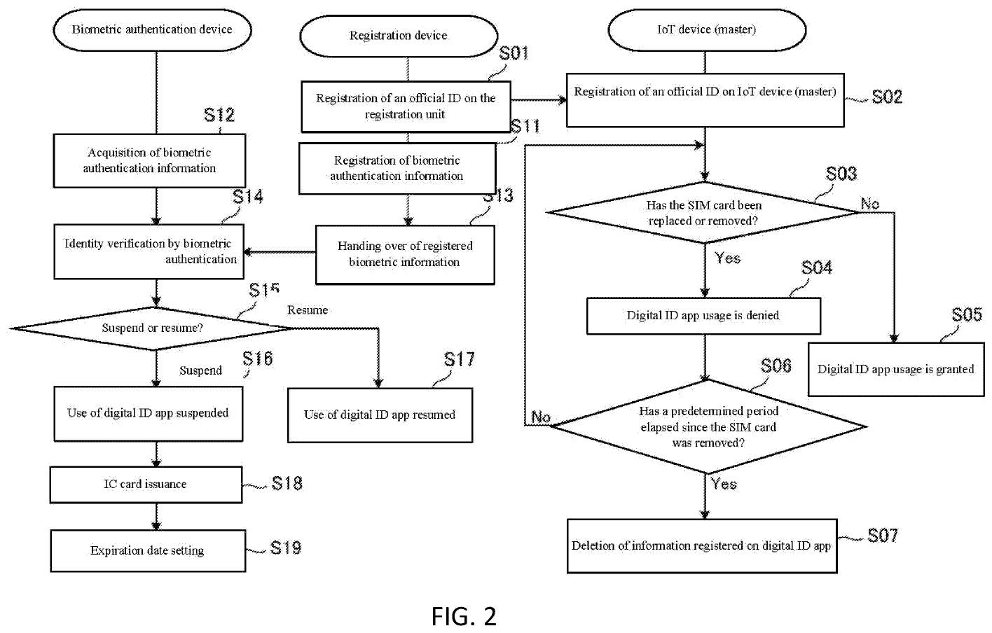

The processing involving registration device 10, biometric authentication device 13, and IoT device (master) 1 is explained with respect to FIG. 2. A flowchart illustrating the steps from acquiring a digital ID to its deletion in a digital authentication system is shown in FIG. 2.

The registration process of digital ID in Digital Authentication System 100 is described with respect to FIG. 2.

Even though acquiring an IoT device (master) 1 illegally is difficult, having a digital authentication system would be meaningless if fraud can be committed while registering an official ID to the device. Therefore, official ID information such as My Number, driver's license, or insurance card is registered (S01) on digital ID app 2A and recorded (S02) in digital ID app 2A through registration unit 11 of the registration device 10 installed in public institution 9, such as a government office, etc.

The registration process of an official ID on digital ID app 2A through registration device 10 should preferably be performed under human supervision.

If illegally acquiring an IoT device (master) 1 or registering an official ID is difficult, there is a risk that IoT device (master) 1 with an official ID registered through regular procedures may be resold. Therefore, usage management module 3 will deny (S04) the use of digital ID app 2A in IoT device (master) 1 that does not have a SIM card inserted or IoT device (master) 1 wherein the SIM card has been replaced (S03: Yes). Access (S05) is granted for using the digital ID app 2A in IoT device (master) 1 with a SIM card inserted.

In addition to this, resale can be prevented by limiting the number of units of IoT device (master) 1 that can register an official ID on digital ID app 2A to one per person and by operating without issuing physical cards when an official ID is registered to digital ID app 2A.

When disposing of an IoT device (master) 1 with digital ID app 2 installed, all information must be deleted securely. Therefore, deletion module 4 deletes (S07) the information registered in digital ID app 2A when a predetermined period has elapsed (S06: Yes) after the SIM card is removed from the IoT device (master) 1. Deletion module 4 returns to step S03 until a predetermined period elapses (S06: No) after removing the SIM card from the IoT device (master) 1.

If the IoT device (master) 1 installed with the digital ID app 2A is lost or stolen, the use of the device must be suspended immediately. Therefore, registration device 10 installed in public institution 9 is equipped with a biometric information registration unit 12 for registering the biometric information, and it registers (S11) the biometric information of the IoT device (master) 1 owner.

The biometric authentication unit 14 of the separately provided biometric authentication device 13 acquires the biometric authentication information of the user (S12), has the registered biometric information handed over from the biometric information registration unit 12 (S13), and performs identity verification (S14) by comparing the acquired biometric information with the registered biometric information, and usage management module 15 suspends (S16) the use of digital ID app 2A based on the instruction (S15: Suspend) of the verified user.

When a lost IoT device (master) 1 is found before any registration changes are made to the IoT device on registration device 10, the use of digital ID app 2A, which had been suspended, must be resumed. To this end, biometric authentication unit 14 of the biometric authentication device 13 performs biometric authentication, and the usage management module 15 releases (S17) the usage suspension of digital ID app 2A based on the instruction (S15: Resume) of the user whose identity is confirmed.

If the use of digital ID app 2A is not resumed after a certain period has elapsed since usage suspension by the usage management module 15, deletion of the data of digital ID app 2A is preferable. To this end, equipped with deletion module 4 that deletes the data of the digital ID app 2A when a certain period has elapsed after the usage suspension is instructed by usage management module 15 of the biometric authentication device 13.

If the IoT device (master) 1 with the digital ID app 2A installed is lost or stolen, promptly issuing IC cards that can be used as an alternative to digital ID applications is preferable. The IC card issuance unit 16 issues (S18) an IC card that can be used as an alternative to the digital ID app 2A based on the personal information stored in the management server 18 when the biometric authentication is performed by the biometric authentication unit 14 and the identity is confirmed.

The expiration date setting module 17 sets (S19) the expiration date of the IC card to prevent resale of the IC card.

When official ID information is registered to a new digital ID app 2A through registration unit 11 of registration device 10 due to a contract change, etc., of the IoT device (master) 1, the information recorded in recording module 19 of management server 18 must be updated. Therefore, digital ID app 2A notifies the information of the new IoT device (master) 1 to the management server 18 using notification module 7.

When the registration of the new IoT device (master) 1 is notified to the management server 18 by the notification module 7 of the digital ID app 2A, the management server 18 equipped with notification module 21 notifies the usage suspension of the digital ID app 2A before the registration change to the website 24 recorded in the recording module 19 of the management server 18 and website 24, notified of the usage suspension by the notification module 21 of the management server 18, is equipped with an online usage suspension module 27 that suspends the use of the digital ID app 2A before the registration change. The description of the website 24 recorded in the recording module 19 of the management server 18 will be explained later.

The biometric authentication performed by biometric authentication device 13 should preferably use fingerprint and vein authentication.

Since digital IDs are also intended to be used as credential information for various financial services, biometric authentication should be preferably limited to specific purposes.

From the perspective of reducing the burden of cybersecurity measures and mitigating the oligopoly of personal information, using plain text for communication over the Internet is preferable to the extent possible.

For example, communication is safe even when sent in plain text using the HTTP protocol instead of the HTTPS protocol if the value of the credential information issued by the digital ID app 2A is encrypted and sent. However, considering the risk of interception and decryption, hashing the credential information issued by digital ID app 2A using a combination of multiple elements is preferable.

Furthermore, by incorporating a unique identifier, which is difficult for users with general IT literacy to acquire, as an element in hash value generation, stealing credential information by phishing scams, etc., becomes impossible.

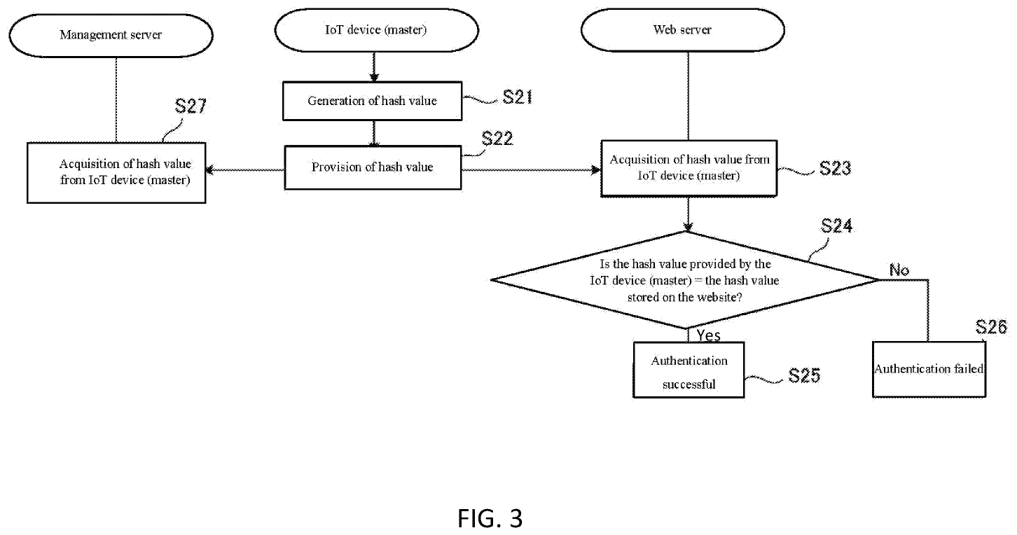

The authentication process using the digital authentication system 100 is described below with respect to FIG. 3. A flowchart illustrating the steps of the authentication process in a digital authentication system is shown in FIG. 3.

Hash value generation module 5 generates (S21) a hash value from the unique identifier of the official ID (personal identity number, driver's license number, etc.) and the unique identifier of the IoT device (master) 1 on which the digital ID app 2A is installed.

When browsing website 20 over the Internet, hash value provision module 6 provides (S22) the hash value generated by the hash value generation module 5 to website 24 and website 24 acquires (S23) the hash value from IoT device (master) 1.

The hash value comparison module 25 of website 24 compares the hash value provided by the hash value provision module 6 with the hash value stored on website 24 or management server 18 and performs user authentication (S24). Authentication is successful (S25) if the hash value matches, and authentication is failed (S26) if the hash value does not match. The services on website 24 can be accessed if authentication is successful.

Hash value provision module 6 sends (S27) the hash value generated by the hash value generation module 5 to management server 18, considering the risk of tampering with digital ID app 2A.

Also, management server 18 should be configured not to be accessible from the Internet, and various personal information other than hash values should be stored in the recording module 19 of the management server 18, and preferably information stored in the recording module 19 of the management server 18 should be considered as authentic.

Since the accuracy of identity verification using the digital ID app 2A is extremely high, various data that could not be disclosed online until now (payment status of tax and social insurance, health insurance usage status, etc.) is expected to be confirmable online.

Residence certificates, etc., can be fraudulently obtained. Accepting documents such as residence certificates, etc., required for various procedures through website 24 and performing identity verification using the digital ID app 2A would make fraud difficult and streamline the service counter operations of government offices.

There have been cases of manipulating reviews by recruiting product testers for free on the condition that they submit reviews or by paying them money in return for their reviews. Freezing the account of violators is one option to curb such incidents. However, it is preferable to identify the offending account and impose a temporary ban on re-creation, as violators can resume posting reviews by recreating accounts.

To this end, the usage restriction module 26 of website 24 allows reviews for products and services only when user authentication has been performed by the hash value comparison module 25 or by accounts that have completed one-time password authentication when a one-time password is sent by SMS to a non-prepaid cell phone.

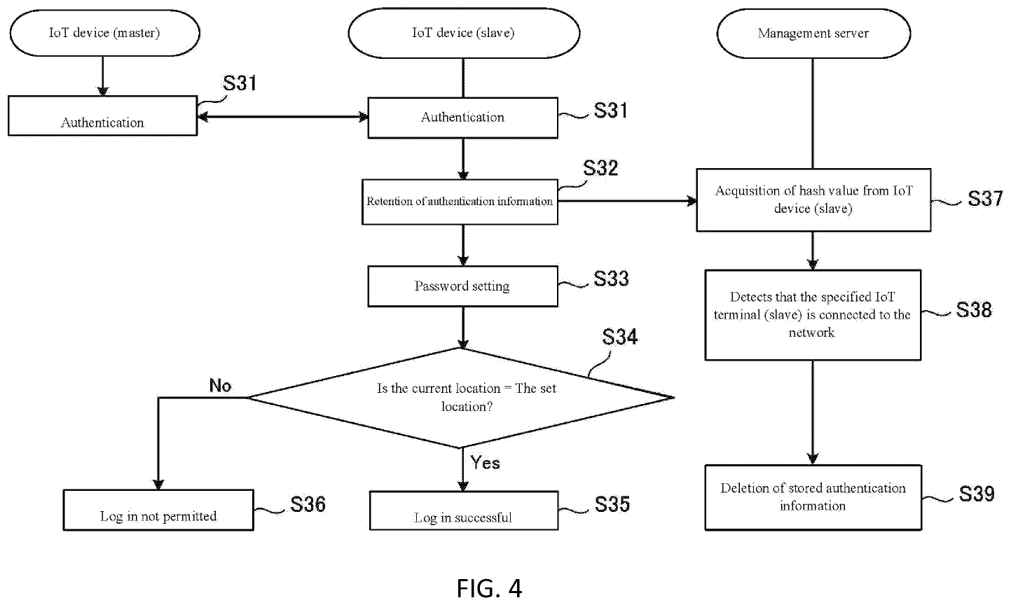

The process of using an IoT device (slave) in the digital authentication system 100 is described, referring to FIG. 4. FIG. 4 is a flowchart illustrating the process flow of acquiring a digital ID at an IoT device (slave) in a digital authentication system.

Preferably, identity verification using the digital ID App 2A should be available on all IoT devices owned by individuals. Thus, the authentication module 29 of IoT device (slave) 28 performs authentication (S31) through an IC reader between IoT device (master) 1, where Digital ID app 2A is installed and IoT device (slave) 28, where digital ID app 2B is installed.

The authentication information retention module 30 holds (S32) the authentication information authenticated by authentication module 29 in the device.

The authentication information held in the authentication information retention module 30 should preferably be a hash value generated by the hash value generation module 32 of the digital ID app 2B.

Therefore, the hash value generation module 32 generates a hash value from the authentication information retained by the authentication information retention module 30 and the unique identifier of the IoT device (slave) 28 and uses it as authentication information.

Further, since the hash value generated in step S32 should preferably be stored in the management server 18, the hash value provision module 6 provides the value to the management server 18, and management server 18 acquires (S37) the hash value of the IoT device (slave) 28. Management server 18 will be described later.

Password setting module 31 in the IoT device (slave) 28 allows the setting (S33) of an arbitrary password when the authentication information is held by the authentication information retention module 30.

It is anticipated that kiosk terminals may be installed to hold the authentication information in the authentication information retention module 30 to resell the IoT device (slave) 28 and steal personal authentication information. The location information setting module 33 sets the location information where log in to the IoT device (slave) 28 is possible using the password registered in the password setting module 31.

Limiting the location information that can be set to only one location near the address registered in the official ID is preferable.

By doing this, even if the IoT device (master) 1 on which the digital ID app 2A is installed is lost, identity verification can be performed with the IoT device (slave) 28 on which the digital ID app 2B is installed at one's home, and resale of the IoT device with authentication information retained in the authentication information retention module 30 can be prevented.

If the current location during the login operation is the location set by the location information setting module 33 (S34: Yes), the authentication module 29 allows log in (S35) to the IoT device (slave) 28 by entering the password during the period when authentication information is retained.

On the other hand, login will not be permitted (S36) if the location (S34: No) is not as set by the location information setting module 33.

A remote wipe must be performed if a personally owned personal computer or tablet with the authentication information retention module 30 is stolen or lost.

Therefore, the management server 18 is equipped with a remote wipe module 22 that instructs the deletion of authentication information held in the authentication information retention module 30 of the IoT device (slave) 28.

When the remote wipe module 22 detects (S38) that the specified IoT device (slave) 28 is connected to the network, it deletes (S39) the stored authentication information.

When applying for a service that requires online identity verification, the identity verification is performed using a copy of an official ID or a photo captured with a camera. However, since detecting a forged ID is difficult, performing identity verification using a digital ID is preferable.

Therefore, it is preferable that the hash value comparison module 25 provided in website 24 performs the identity verification by comparing the hash value sent from the IoT device (master or slave) 1 or 28 with the hash value in the management server 18 or the hash value stored on the website 24.

Even credential information used for online bank accounts and credit card payments can be stolen and used fraudulently through phishing scams. Therefore, online payments of bank account, credit card, etc., are preferable to be carried out using digital ID apps 2A, 2B.

Therefore, the digital ID app is equipped with a hash value generation module 5 or 32 that generates a hash value based on a unique identifier of the bank account, credit card number, etc., and the unique identifier of the user when a bank account or credit card, etc., is created on the website of financial institutions, and the generated hash value is stored in the digital ID apps 2A, 2B, the authentication information retention module 30, and the management server 18.

Additionally, when a hash value is generated for online authentication, and users enter their bank account, credit card information, etc., to make a payment, there is a possibility that they may become victims of phishing scams.

Therefore, the website is equipped with an online usage suspension module 27 that does not authenticate even if a bank account or credit card information, etc., is entered on the website 24 when a hash value for authentication is generated from a unique identifier of the bank account or credit card number, etc., and the unique identifier of the user.

If login with digital ID app 2A is made mandatory for identity verification to access services that create NFTs (non-fungible tokens) and generate a blockchain for digital content based on the hash values generated by the digital ID apps 2A, 2B, identifying the content creators will become easier.

For example, the founder of Twitter auctioned off the first tweet, which was sold for approximately $300 million. In this example, if the energy consumption required for mining is sufficiently reduced, posts on social media can be expected to be distributed as NFTs. In this way, when value is generated for posts on social media, and users who follow the rules set by service providers of social media platforms are allowed to post NFTs on the platform, the number of creators using social media is expected to increase, leading to the active dissemination and circulation of valuable information.

Therefore, when enabling the posting of NFTs on social media platforms, it is preferable to mandate identity verification using the digital ID apps 2A, 2B, according to this embodiment.

There is a high risk of plagiarism if NFTs are allowed to be posted on social media platforms; however, by mandating identity verification using digital ID apps 2A, 2B for posting NFTs, users who intentionally engage in plagiarism can be prohibited from posting NFTs, thereby providing a deterrent effect.

There have also been instances of purchasing tickets for live events, such as concerts, etc., intending to resell them. For limiting such cases, adopting identity verification by digital ID apps 2A, 2B, according to this embodiment for website 24 that sells tickets and website 24 that resells tickets is preferable, issuing electronic tickets and linking the information of the electronic ticket to digital ID app 2A is preferable.

Additionally, the operation of website 24, which sells electronic tickets, should prioritize users who have undergone identity verification with digital ID apps 2A, 2B according to this embodiment for purchasing electronic tickets, suspending accounts that engage in the resale of electronic tickets for profit from using website 24 (for ticket sales and resale) can effectively suppress the practice of profiteering through ticket reselling.

Verification of electronic tickets is expected to be carried out using the digital ID reading app 35 installed at live events, etc. When the digital ID app 2A is held over digital ID reading app 35, displaying the reservation details or issuing in paper form is preferable.

The Hotel Business Act mandates hotels to maintain a guest list, but providing false information is easy, and the check-in and check-out procedures also pose a burden on the accommodation industry. For this reason, it is preferable to adopt identity verification by digital ID apps 2A, 2B according to this embodiment on website 24 for booking accommodations and linking the reservation information to digital ID app 2A.

It is preferable to use digital ID apps 2A, 2B to perform identity verification on the website 24 when reserving accommodation, and subsequently, when visiting the accommodation facility and performing the check-in process, a key should be issued or digital ID app 2A should be enabled for use as a key when digital ID app 2A is held over digital ID reading app 35 installed at the accommodation facility

The burden of key management can be reduced by replacing keys to real estate properties, etc., with digital ID app 2A. For this reason, it is preferable to prepare website 24 to handle real estate contracts and key management and adopt identity verification using digital ID apps 2A, 2B according to this embodiment for website 24, which handles real estate contracts and key management, and link the reservation information to digital ID app 2A.

After identity verification has been performed by digital ID apps 2A, 2B on website 24 managing real estate contracts and key management, and signing the real estate contract, unlocking and locking real estate properties by holding the digital ID app 2A over digital ID reading app 35 installed at the real estate property during subsequent visits to the real estate property is preferable.

Digital ID app 2A may also be used for key management of vehicles, ships, etc., using the same approach as that for key management of real estate.

Internet communications must be sufficiently plain text, and personal information (including browsing history) must be collected by service providers commissioned by the government to the extent determined by law and managed based on unique identifiers that can identify an individual to sell this information.

For this reason, equipped with a hash value provision module 6 that provides hash values when browsing website 24, and a web browsing history management DB 34 that stores the web browsing history based on the provided hash value.

When using digital IDs for in-person identity verification, it is preferable to read information in digital ID apps 2A, 2B with a reading application and display personal information, including a photograph of the face. Therefore, a digital ID reading app 35 is provided, which displays information registered in the digital ID app when an IoT device (master or slave) 1 or 28 with digital ID apps 2A, 2B installed is held over an IC reader.

When verifying identity using information displayed on an IoT device owned by an individual subject to identity verification, such measures are necessary since it is anticipated that there will be cases where digital ID apps 2A, 2B are spoofed by combining an image display app with a forged image.

When specialists such as administrative scriveners, etc., act as representatives of clients for various procedures through a power of attorney, there is a risk of fraudulent creation of a power of attorney and carrying out the procedures fraudulently; therefore, when a client delegates work to a specialist on website 24, hash value comparison module 25 is provided for identity verification, a notification module 7 is provided to notify the client's digital ID apps 2A, 2B that a procedure was performed by a proxy when the delegated specialist performs the procedure as a proxy of the client at a designated institution, and the approval module 8 is provided by which the client approves the contents notified by notification module 7.

When the specialist delegated by the client performs a procedure on behalf of the client at a designated institution, the procedure should preferably be performed electronically. However, in case the procedure is carried out in writing and identity verification is performed by hash value comparison module 25 when the work is delegated, a unique identifier should preferably be output to identify the request, which can then be submitted in writing to the designated institution by outputting the unique identifier on paper using a 2D barcode, etc.

When the 2D barcode is read by a reading device installed at the designated institution, if the client's digital ID apps 2A, 2B are notified that the application has been submitted and the history of approval by the client is maintained, system renewal can be kept to a minimum.

Using plain text for communications on the Internet is important to free personal information from the oligopoly of some companies. However, there is a risk of inadvertently making communications that should be encrypted in plain text if plain text communication is promoted. Therefore, it is preferable to establish guidelines for communications that should be encrypted and periodically verify web pages violating these guidelines are not publicly available in plain text.

For this reason, equipped with a bot 36 that crawls web pages, and the bot is equipped with an alert module 37 that raises an alert when a web page that meets the prescribed conditions (email, messaging app, cloud storage, etc.) is published in plain text.

The digital authentication system, according to this embodiment, is suitable to promote plain text internet communications by preventing unauthorized hijacking of accounts, reducing the burden of corporate cybersecurity measures by making it easier to deal with cyberattacks, and promoting the distribution of personal information.

The following modifications of this embodiment are also possible.

The digital authentication system of the 1st aspect is equipped with a digital ID app installed on an IoT device (Master) with a SIM card and a registration unit to register official ID information in a digital ID app through a registration device installed in a public institution, etc.

The digital authentication system of the 2nd aspect is equipped with a notification module that notifies the information of the IoT device (master) on which the digital ID app is installed to the management server, and the management server is equipped with a recording module that records the information notified by the notification module of the digital ID app.

The digital authentication system of the 3rd aspect is equipped with an acquisition module that acquires the credential information of the digital ID owner from the credential information management server, and the management server is also equipped with a recording module that records the credential information acquired by the acquisition module.

The digital authentication system of the 4th aspect is equipped with a usage management module that disallows the use of the digital ID app in an IoT device (master) that does not have a SIM card inserted and an IoT device (master) on which a SIM card has been replaced and a deletion module that deletes information registered in the digital ID app when a certain period has elapsed after the SIM card has been removed from the IoT device (master).

The digital authentication system of the 5th aspect is equipped with a biometric information registration unit that registers biometric information using the registration device installed in a public institution. A separately provided biometric authentication device is equipped with a biometric authentication unit that performs biometric authentication based on the biometric information registered by the biometric information registration unit and a usage management module that suspends the use of the digital ID app based on the instructions of the user whose identity has been verified by performing identity verification with the biometric authentication unit.

The digital authentication system of the 6th aspect is equipped with a usage management module that releases the usage suspension of the digital ID app based on the instructions of the user whose identity has been verified by the biometric authentication unit of the biometric authentication device.

The digital authentication system of the 7th aspect is equipped with a deletion module that deletes the data of the digital ID app when a certain period has elapsed after the usage suspension is instructed by the usage management module of the biometric authentication device.

The digital authentication system of the 8th aspect is equipped with an IC card issuance unit, which issues an IC card that can be used as an alternative to the digital ID app based on personal information stored in the management server when the identity of the user is verified by performing identity verification with the biometric authentication unit.

The digital authentication system of the 9th aspect is equipped with an expiration date setting module that sets the expiration date of the IC card.

The digital authentication system of the 10th aspect includes a notification module in the digital ID app that notifies the management server of the new IoT device (master) information when official ID information is registered in a new digital ID app through the registration unit of the registration device.

The digital authentication system of the 11th aspect is equipped with a notification module that notifies of the usage suspension of the digital ID app before the registration change to the website recorded in the recording module of the management server. The website notified of the usage suspension by the notification module of the management server is equipped with an online usage suspension module that suspends the use of the digital ID app before the registration change.

The digital authentication system of the 12th aspect includes a hash value generation module in the digital ID app that generates a hash value from the unique identifier of the official ID (personal identity number or driver's license number, etc.) and the unique identifier of the IoT device (master) on which the digital ID app is installed.

The digital authentication system of the 13th aspect is equipped with a hash value provision module that sends the hash value generated by the hash value generation module to the management server.

The digital authentication system of the 14th aspect is equipped with a hash value provision module that provides a hash value generated by the hash value generation module when browsing a website, etc., on the Internet. The website has a hash value comparison module that compares the hash value provided by the hash value provision module with the hash value stored on the website to perform user authentication.

The digital authentication system of the 15th aspect includes a website equipped with a usage restriction module that allows reviews for products and services only when user authentication has been performed by the hash value comparison module or by accounts that have completed one-time password authentication when a one-time password is sent by SMS to a non-prepaid cell phone.

The digital authentication system of the 16th aspect is equipped with an authentication module that performs authentication through an IC reader between the IoT device (master) and the IoT device (slave) on which the digital ID app is installed, and an authentication information retention module that retains the authentication information authenticated by the authentication module in the device.

The digital authentication system of the 17th aspect is equipped with a password setting module that can set an arbitrary password when the authentication information retention module retains the authentication information, and the authentication module allows log in to the IoT device (slave) by entering the password during the period when the authentication information is retained.

The digital authentication system of the 18th aspect is equipped with a hash value generation module that generates a hash value from the authentication information held in the authentication information retention module and the unique identifier of the IoT device (slave).

The digital authentication system of the 19th aspect includes a management server equipped with a recording module, which records the IoT device (slave) that has retained the authentication information using the authentication information retention module, and a remote wipe module that instructs the deletion of the authentication information retained in the authentication information retention module. The remote wipe module deletes the information when the specified IoT device (slave) is connected to the network.

The digital authentication system of the 20th aspect is equipped with a location information setting module to set the location information that allows log in to the IoT device (slave) using the password registered in the password setting module.

The digital authentication system of the 21st aspect is equipped with a hash value generation module that generates a hash value based on a unique identifier of the bank account or credit card number, etc., and the unique identifier of the user when a bank account or credit card, etc., is created on the website of a financial institution.

The digital authentication system of the 22nd aspect is equipped with an online usage restriction module that does not authenticate even if a bank account or credit card information, etc., is entered on the website when a hash value for authentication is generated from a unique identifier of the bank account or credit card number, etc., and the unique identifier of the user.

The digital authentication system of the 23rd aspect is equipped with a hash value provision module that provides hash values when browsing websites and a web browsing history management DB that stores the web browsing history based on the provided hash value.

The digital authentication system of the 24th aspect is equipped with a digital ID reading module that displays information registered in the digital ID app when the IoT device on which the digital ID app is installed is held over the IC reader.

The digital authentication system of the 25th aspect is equipped with a hash value comparison module that performs identity verification based on the comparison results of hash value when a client delegates work to a specialist on the website, such as an administrative scrivener, etc., who performs various procedures at the designated institution on behalf of the client using a power of attorney, equipped with a notification module to notify that a procedure has been performed by an agent on the digital ID app of the client, and an approval module that allows the client to approve the contents notified by the notification module.

The digital authentication system of the 26th aspect is equipped with a bot that crawls web pages, and the bot is equipped with an alert module that raises an alert when a web page that meets the prescribed conditions (email, messaging app, cloud storage, etc.) is published in plain text.

### INDUSTRIAL APPLICABILITY

The present invention is suitable to promote plain text internet communications by preventing unauthorized hijacking of accounts, reducing the burden of corporate cybersecurity measures by making it easier to deal with cyberattacks, and promoting the distribution of personal information.

### EXPLANATION OF THE REFERENCE NUMERALS

2: Digital ID app
2A: Digital ID app
2B: Digital ID app
3: Usage management module
4: Deletion module
5: Hash value generation module
Hash value provision module
7: Notification module
8: Approval module
9: Public institution
10: Registration device
11: Registration unit
12: Biometric information registration unit
13: Biometric authentication device
14: Biometric authentication unit
15: Usage management module
16 IC card issuance unit
17: Expiration date setting module
18: Management server
19: Recording module
20: Acquisition module
21: Notification module
22: Remote wipe module
23: Credential information management server
24: Website
25 Hash value comparison module
26: Usage restriction module
27: Online usage suspension module
29: Authentication module
30: Authentication information retention module
31: Password setting module
32: Hash value generation module
33: Location information setting module
34 Web browsing history management DB
35: Digital ID reading app
36: Bot
37: Alert module
100: Digital authentication system

1. A digital authentication system characterized by comprising a digital ID app installed on an IoT device with a SIM card, and
A registration device installed at an institution that issues My Number card, driver's license, and insurance card, and
The registration device comprises a registration unit that registers My Number card, driver's license, and insurance card on the digital ID app;
A hash value generation module that generates a hash value from the unique identifier of My Number Card, driver's license, and insurance card registered on the digital ID app through the registration unit, and the unique identifier of the IoT device on which the digital ID app is installed,
A hash value provision module that sends the hash value generated by the hash value generation module to the management server,
A hash value provision module that provides the hash value generated by the hash value generation module to the website when the website is browsed;
Wherein the website comprises a hash value comparison module that performs user authentication by comparing the hash value provided by the hash value provision module and the hash value stored on the website or the management server.

2. A digital authentication system, according to claim 1, which is characterized by a registration device installed at an institution that issues My Number card, driver's license, and insurance card, equipped with a biometric information registration unit that registers biometric information,
A separately provided biometric authentication device comprises a biometric information acquisition module that obtains the biometric authentication information of the user;
Wherein the biometric authentication device comprises a function to have the biometric information registered by the biometric information registration unit on the registration device, handed over to it, and to perform identity verification of the user by matching the biometric information obtained by the biometric information acquisition module and the biometric information registered by the biometric information registration unit, and
A usage management module that suspends the use of the digital ID app based on the instruction from the user whose identity has been verified, and an IC card issuance unit that issues an IC card; this card can be used as a substitute for the digital ID app based on personal information stored in the management server.

3. A digital authentication system, according to claim 1, which is characterized by an authentication module that performs authentication through an IC reader between the IoT device (master) and the IoT device (slave) on which the digital ID app is installed,
An authentication information retention module that retains the authentication information authenticated by the authentication module in the IoT device (slave),
A password setting module that can set an arbitrary password when the authentication information retention module retains the authentication information;
Wherein the authentication module comprises a function that allows login to the IoT device (slave) by entering the password during the period when the authentication information is retained on the authentication information retention module,
A location information setting module to set the location information that allows login to the IoT device (slave) using the password registered in the password setting module.

4. A digital authentication system, according to claim 1, which is characterized by a digital ID app comprising of a hash value generation module that generates a hash value based on a unique identifier of the bank account or credit card and the unique identifier of the user when a bank account or credit card is created on the website of a financial institution.

5. A digital authentication system, according to claim 1, which is characterized by a website comprising of a module to delegate work when a client delegates work to a specialist on the website, and the specialist performs various procedures for the work on behalf of the client with a power of attorney, after the identity of the expert is verified by the hash value comparison module that compares the hash value provided by the hash value provision module and the hash value that is stored on the website or the management server,
A notification module to notify the digital ID app of the client that a procedure has been performed by the proxy, when the specialist who has been delegated the work performs the procedure on behalf of the client at the designated institution, and
An approval module using which the client approves the contents notified by the notification module.
